(19) United States
(12) Patent Application Publication
(10) Pub. No.: US 2010/0052971 A1
(43) Pub. Date: Mar. 4, 2010

(54) Device and Method to Evaluate Condition of Concrete Roadways Employing a Radar-based Sensing and Data Acquisition System

(76) Inventor: Sal G. Amarillas, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/512,943

(22) Filed: Jul. 30, 2009

Related U.S. Application Data
(60) Provisional application No. 61/084,895, filed on Jul. 30, 2008.

(51) Int. Cl. G01S 13/89

(52) U.S. Cl. 342/22

(57) ABSTRACT

A vehicle mounted device for producing enhanced images of an underlying roadbed for the roadway on which the vehicle is traveling. The device employs a first RF transmission and second RF transmission communicated through the same individual section of roadbed, to produce two images of the section using software adapted to the task. The two individual images are then combined to yield an enhanced view of the section of roadbed in a third image. Images of sequential adjacent roadbed sections may be stored on a computer and employed to provide a three dimensional image of the underlying roadbed anywhere along the distance traveled and imaged by the device.

This application claims priority to U.S. Provisional Patent Application No. 61/084,895 filed on Jul. 30, 2008 and incorporated herein in its entirety by reference.

### BACKGROUND OF THE INVENTION

1. Field of the Invention

The present invention relates to the inspection of bridge and roadway surfaces for evidence of damage or disrepair from age and corrosion and the elements. More particularly it relates to a device and method employing broadcast and receipt of RF energy to produce a video representation of sub-surfaces of roadways to ascertain the condition of concrete, soil, and reinforcing materials and other subsurface components. The video rendering depicts the roadway and its underlying components with great specificity as to the location and nature of any deterioration in need of repair or retrofit.

2. Prior Art

The infrastructure of the United States and many foreign countries consists of millions of miles of roadways, bridges, and other transportation surfaces. All are in constant need of inspection to ascertain any need for maintenance or repair. As a recent bridge collapse in Minnesota evidences, it is extremely important that structures employed for vehicular and pedestrian traffic are maintained in prime condition. Otherwise, a catastrophic collapse or even a minor failure can occur causing the loss of many lives in addition to causing extensive damage.

Bridges and roadways in modern countries throughout the world are frequently formed of asphalt on top of a support subsurface or of concrete reinforced with steel. The supporting steel or other subsurface materials provide the strength needed for the overlying road surface to enable it to carry the massive weight loads of vehicles and trains and the like. Such roadways are found on soil or over the bridged rivers and canyons or simply on city and state streets.

The employment of metal reinforcement such as steel in the underlying material supporting an overlying roadway provides support to the roadway. The metal reinforcing material such as reinforcing bar or wire mesh, when engaged within concrete road surfaces or support surfaces, produces a structural material that exceeds the strength of either material if employed individually in the same sized structure. This hidden underlying support technology, provided by metal reinforcing material, has enabled roadways to withstand much higher weights for much longer periods than would be possible in an unreinforced roadway surface.

However, metal material, such as steel, oxidizes when in contact with water or air and produces rust. It is said that “rust never sleeps” and consequently, metals such as iron and steel, employed in the reinforcement of roadways, are constantly being oxidized through intended and unintended contact with air, water, salt, chemicals, and other activating materials. Corrosives, such as these and other materials, may come into contact with the metal which reinforces roadways causing failure over time of the reinforcing materials and the roadway itself.

However, because the metal, such as wire mesh and reinforcing bars employed for reinforcement of concrete bridges and roadways, and other reinforced roadways, is purposely surrounded by the concrete or other road material it supports, this corrosion is virtually impossible to discern visually due to the metal being encased in the material is supports.

The concrete or other roadway material situated above a severely corroded steel reinforcement beam, bar, or mesh, can appear in a perfectly normal condition. In fact, the road surface can appear normal and operative for traffic even when inspected for damage by the trained eye of an engineer or maintenance worker. Consequently, it is very hard and time consuming to inspect bridges and roadways for damage from corrosion to internally located metal reinforcements.

Currently, a visual inspection is the most rudimentary and common method of inspection. Inspectors simply look at, and visually evaluate, the road surface. On a bridge, they evaluate the bridge's superstructure for infrastructure corrosion or other problems. When anomalies are observed by an inspector, the areas deemed structurally suspect may then be cored by drilling into the road surface for further investigation. After completion of testing and evaluation, the underlying roadway or roadway on a bridge deck is resurfaced with a tar and asphalt cover until a subsequent roadway or bridge deck replacement occurs.

Another conventionally employed method of such inspection is accomplished by having a worker or an inspector use a tool, such as a metal bar or hammer, to tap on the roadway surface. This can be done whether the roadway is supported by underlying soil or a bridge structure. The tapping sound produced when the tool strikes the exposed roadway surface is essentially listened to by the trained ear of the tapping worker. When a worker with such a trained ear hears a sound discerned as abnormal, the spot on the roadway where the tapping produced the sound is marked using paint or other marking material. Subsequently, at great expense in time and money, the marked spot on the roadway is sound by a repair crew and excavated to reveal the underlying internal metallic reinforcements in a visual inspection. Should it be required thereafter, repairs would be initiated.

Metallic corrosion is not the only culprit in roadway failure. Underlying support materials such as gravel or other layers of material or concrete can become damaged due to hidden water flows, digging by animals, or by a wide variety of problems. Much like the encased metal reinforcement, roadway support failure will eventually cause damage to the overlying roadway and surface.

A mechanical assessment of hidden roadway support material is another method of inspection. This type of inspection requires lanes of traffic, or if on a bridge, the entire bridge itself, to be closed. In such an assessment, first, the overlaying layer of asphalt or other road surface material is removed. Then, testing is conducted by dragging a chain over the suspected deteriorated underlying roadway support area. During this dragging, sound is produced by the chain sliding on the support surface and the inspector listens for auditory anomalies based on his or her experience, which might indicate degraded conditions of the roadway support surface.

As can be discerned, the accuracy and actual success of such an inspection is directly related to the inspector's hearing and the inspector's experience in the field discovering anomalies from different sounds. As also can be ascertained, such a system is highly inaccurate and prone to missing more hazardous conditions than it finds.

In addition to the high cost, formidable manpower, and inaccurate results using such conventional methods of inspection, there are many other drawbacks to the current method of inspection of roadways for hidden damage in the underlying support and roadway surface. The greatest is the subjectivity and inaccuracy of such methods since there is no visual inspection of encased reinforcing material and only a guess based on experience and sound in limited positions on the roadway surface. Traffic control and roadway and bridge closures will hinder not only commuters, but the transportation of goods and services and the repair crews to fix the discerned problem. Further, there are safety hazards involved when the maintenance work crews are placed within the lanes of flowing of traffic to execute such inspections.

As a consequence conventional methods of hidden roadway and roadway support damage is inaccurate at best and requires years of apprenticeship of the worker to train their ears to hear purported sounds indicating internal corrosion or roadway support damage. Other methods are employed for such inspection and marking of roadways, all equally antiquated, expensive and slow.

As advances in technology have become available, ground-penetrating radar (GPR) is one attractive method to enhance bridge inspection methods. The Lawrence Livermore National Laboratory introduced a ground penetrating radar system named HERMES or High-speed Electromagnetic Roadway Mapping and Evaluation System in an attempt to use such technology to image bridge decks. This system employs an array of radar elements which mono-statically pulsed the roadbed underlying the roadway to image a two meter wide, thirty centimeter deep, swath of roadway on a bridge deck at near highway speeds.

However, this and other radar systems have not been able to perform as expected. This is especially true because the produced visual images of the roadbed under the inspected roadways failed to provide sufficient detail of the roadbed strata to ascertain what if anything was amiss. This inability to ascertain many defects due to poor imaging has made conventional radar or RF imaging systems too error prone for them to be effective.

As such, there is a continuing unmet need for an improved device and method for the accurate and timely inspection of the hidden support layers underlying roadways and bridge supported road. Such a system should clearly image and thereby identify any underlying hidden internal corrosion and resulting damage to the metal support material forming the reinforcing structure. Such a device should provide detailed pictures or depictions of the underlying strata or support structure of the overlying roadway which may appear normal and undamaged. Such a system should produce, easily, visually inspected depictions of the strata below the surface of concrete or asphalt which can then be easily inspected for damage. Such a system should employ digital imaging to thereby allow multiple images of the same underlying roadway to be combined and thereby produce detailed images which can by viewed by a human, or using software, inspected using a computer inspecting the digital images.

Such a device should provide such detailed visual depictions which are concurrently registered or referenced to exact positions on the road surface and on the earth, so that if excavation should later be necessary, the identified damage will be highly accurate for an identified location. Further, such a device and method should provide for such inspections and digital imaging and mapping of potential problems without interfering with the normal traffic on the roadway lest traffic jams result.

Still further, such a device and method should employ a means to store data of the digital video depiction concerning the discovered defects and the exact terrestrial locations of such identified corrosion and damage, which may then be inspected at a remote site by one or more people, so that the nature of the damage may be ascertained by persons trained to recognize it and calculate the needed repairs. Finally, such a device and method should concurrently be able to physically mark a trouble spot on the roadway with a visual means to identify the spot so as to allow repair personnel an easily employed visual means to identify a target position above a hidden underlying problem and thereby allow for excavation accurately at a subsequent time.

### SUMMARY OF THE INVENTION

The device and method herein disclosed and described achieves the above-mentioned goals and objects, through the provision of a vehicle mounted electronic inspection system for roadways and underlying roadbeds whether on land or supported upon bridges. It further can provide a concurrent virtual or physical target marking of the roadway being inspected, at the exact position where a potential problem has been discerned, thereby providing a visual target to maintenance personnel on the viewable roadway surface in the event of a subsequent repair being initiated.

Further, the device and method herein, may produce a GPS terrestrial mapping of the roadway surface which is inspected and tag images or sections needing attention or repair with GPS coordinates as a means to ascertain a location for users for any potential repair points thereon. Due to the ever increasing accuracy of GPS systems, subsequent repair crews will have the exact terrestrial coordinates of needed repairs of the roadway to find the correct positions to work.

The disclosed device, enabling the method herein, employs the broadcast of directed RF energy into the roadway and underlying support surface and a receipt of reflected RF energy from one or a plurality of such broadcasts. The broadcast and receipt and processing components of the system may be mounted in a trailer or on a vehicle. The system, using a computer running software adapted to the task or receiving and storing the reflected RF energy, can be employed on a vehicle at traffic speeds over a roadway or bridge deck to collect information about the roadway subsurface, without causing traffic jams or potential accidents commonly caused by conventional methods above.

The system in a preferred mode employs a plurality of broadcasts of RF energy into the roadbed and concurrently employs receiving components for the plurality of reflected RF signals. Using this multiple signal and receipt approach, the system can thereby gather data from the reflected signals to accurately render visualizations of the underlying roadway and support materials for a depth of up to thirty centimeters or more below the viewable roadway top surface. Using broadcast antennas operatively sized and positioned, the signal or RF energy may be broadcast and then received as a reflection to yield visual images of the concrete, reinforcing bars or meshes, and other support and reinforcing materials in the roadbed below the road surface. The system broadcasts pulses of RF energy in swaths up to twenty feet wide, which are reflected back to receiving antennas after travel through the roadbed substrates. The pulsed broadcasts divide the roadway and underlying substrate into sections which are consecutively scanned to thereby allow continual inspection of an entire lane of traffic by the system on a vehicle moving at regular traffic speeds. The timing of the pulses of the broadcast RF energy may be adjusted to the speed of the vehicle to yield the images of the sections of roadway.

The disclosed device and method employs a Phased Array Radar or similar system of broadcast and receiving antennas to direct RF energy into, and receive reflections of such RF energy from, the hidden underlying roadbed of support material and the roadway material itself. Upon receipt of the reflected RF energy in an analog form, each stream of RF energy, using software adapted to the task, produces an image of the roadbed and substrates of the underlying surface in sections or consecutive slices of the roadway. Particularly preferred for yielding the best imaging, the system employs multiple images of the same sections of roadway using multiple transmissions and reflections therefrom. The multiple transmissions may be employed multiple RF frequencies and or angles of transmission and reflection of the broadcast and received RF energy. Each such transmission and reflection of a particular slice or section of the roadway yields a signal which will yield an image using software and the reflected individual signals.

The multiple images, from the multiple transmissions and reflections are converted to images in digital form, using software adapted to the task. Then, the images are then combined into a single image or graphic representation of the section of roadway and the roadbed of underlying materials. The RF energy, broadcast at different frequencies and/or at different broadcast and receipt angles, when reflected an used for imaging, will produce better images of specific materials, depending on the frequency employed and the angle of the transmission and reflection.

For example, a first frequency of RF energy may be broadcast into the roadway in an electronic slice through a section of roadway and underlying roadbed surface. Using the reflections of this first RF energy at the first frequency, can produce a better image of the solid solution of concrete or asphalt than of metal. A second stream of broadcast RF energy, at a different angle or in most cases at a different frequency, is directed into the same section of roadway and roadbed as the first. This second broadcast, when reflected, may yield better detailed images of metal, but less accurate images of surrounding concrete or asphalt. Therefor this second broadcast stream of RF energy will produce better images of underlying reinforcing bars, metal screens, and other metal supports in a second image of the same slice of the roadway as the first.

The multiple images of roadbed sections so produced, using software adapted to the task of employing reflected RF energy to yield an image, are digitized for electronic storage and display. In a next step, the images formed from the plurality of transmissions and reflections are overlain or combined using software adapted to combine digital images to thereby yield a single image of the individual slice of roadway into which the two separate RF energy streams were broadcast. The system herein may employ two or more transmissions and resulting reflections to yield digital images for combination into a combined image of a roadbed section. Three or more such RF transmissions might be employed at frequencies and angles to the roadbed adapted to provide resulting images which better detail different aspects of the make up of the roadbed.

The resulting combined images, of each section of the roadbed and roadway, provide excellent detail of the underlying layers of non-metal material, as well as an accurate and detailed image of the underlying metal support materials at their positions in the layer of non-metallic materials underlying the road surface.

Each pulse, which is broadcast and received from the moving vehicle on which the broadcast and receiving antennas are located, yields a separate sliced view of a section of the roadway and underlying roadbed on which the vehicle travels. Each section, formed of the plurality of images, of the first and second or more energy streams so reflected, is stored in memory.

Using GPS monitoring components, each such digitally imaged section of roadway is identified for its terrestrial position on the earth, as well as its location to adjoining sections of the roadway. Software adapted to producing video depictions from one or more of the already combined digitized video images of individual sections through the roadbed, can combine these individual sectional images, from any number of adjoining such sectional images through the road, to produce a virtual image depicting the underlying strata, roadway material, and reinforcing material of the roadbed, from any angle.

Thus, using thousands of such sliced sectional images, each produced by combining digitized images from different RF transmissions and resulting reflections, and software adapted to combine and isolate them for a video display, a user may view the road from above, below, or from the sides of individual slices through the roadway.

Each such sliced or section image, being a combined image from at least two different RF energy reflections at frequencies and/or angles adapted to highlight a particular roadbed component, provides a virtual image of the roadbed which allows for easy identification of problems, where they exist, how deep in the road they exist, whether it is metal corroding, cracks in the concrete or asphalt, missing underlying soil, or any number of problems which cannot be seen from above the roadway.

The system employs a plurality of broadcast antennas, operatively engaged to transmitters and a plurality of respective receiving antennas operatively engaged to receivers, for each broadcast RF energy stream. The receiving and broadcast antennas may be located on the vehicle to yield bistatic angles for the broadcast and receipt of each pulse of broadcast energy into the roadway surface, or may be located to yield the best angles of broadcast and reflection for the image desired of the roadbed section.

In addition to the visual images produced, which may be inspected by users, by tracking the amplitude of each of the plurality of broadcast RF signals, and the respective phase of each such broadcast RF signal, relative to the individual respective reflected signals received, a dielectric constant for any point in any sectional electronic image through the roadbed may be determined. Using determined lookup tables of the values of individual dialectic constants, which are related to individual physical materials, and comparing each determined dialectic constants for each point in the sliced view through the roadway to the table, the material existing at any such point in each slice through the roadway may be determined. Thus, metal may be determined from concrete, and by type. Air adjacent to the metal may show air pockets. Rust on the metal at its point in a sliced view, will have a reflected energy return showing it is rust by the determined dialectic constant.

As a consequence, by assembling virtual views of the roadway with a plurality of adjoining sections, the existence of cracks where air is positioned, may be determined, as well as their length and depth. Rust on reinforcing metal may also be determined and its exact position noted. Other defects may also be identified by the determined dialectic constant determined from the plurality of RF energy streams combined to yield a sliced sectional view through the roadbed, by using the determined dialectic constants at each point and the lookup table for such constants. When employing software adapted to identifying each point's dialectic constant and looking up a value on the stored table of materials relative to dialectic constant, an accurate representation of the underlying surface of an entire bridge or roadway surface for cracks, rust, metal degradation and other defects may be ascertained.

Because each such section view through the roadbed is also associated with a GPS coordinate, the terrestrial location of any crack, rust, air pocket, or other device, may be determined within inches and stored in computer memory and provided at a subsequent time.

Using broadcast antennas and relieving antennas mounted on the vehicle, accurate renditions of underlying roadbed strata and surfaces may be produced at regular traffic speeds. As the vehicle drives over the surface of the roadway, each broadcast antenna pulses a signal generated at a frequency determined, and/or angle determined, from a transmitter. Receiving antennas receive the reelected energy from each respective transmission and store it an individual slice of the roadway. Concurrently, using a GPS tracking device, GPS location tags for the individual sections rendered are related to it. The plurality of sectional images, late yielded from combined RF reflections of each section at different frequencies or angles, can thus be located terrestrially with extreme accuracy with the GPS location tags associated to each sliced view.

The broadcast and receiving antennas on the vehicle which pulse an RF signal from a transmitter at the plurality of different broadcast frequencies or angles, need not be parallel or in the same position to produce the sliced electronic view rendering through the roadway. Instead, a first antenna may transmit a pulse from a transmitter, through the roadway at a first point, from a first position on the vehicle. A trailing antenna engaged to a transmitter on a second frequency, is then triggered using computer software and an optical tracking means to track and ascertain the distance to the overhead point where the first antenna's broadcast pulse occurred. This delays the second broadcast at the second frequency or angle, until the second antenna is positioned over a point in the roadway which will yield a reflection of signal through the same section of roadway as the first broadcast.

The received reflected signals from each respective pulsed signal from each antenna, will then each render an individual software-generated image of the same section thorough the pavement and roadbed. These individual images of the same section are digitized allowing them to be combined by software, to yield assembled images through the roadbed with such an image enhanced for desired elements of material in the roadway. This enhancement of the imagery of each section as noted is provided by employing broadcast frequencies and or angles for the signal radiated from transmitters, to each of the first and second or more antennas. The RF frequencies and/or angles of transmission, are employed based on their individual optimization characteristics for a desired material in the roadbed sections. Consequently, should a user wish to specifically focus on a certain type of material in the underlying roadway, which is identifiable using a known dielectric constant for the desired material from the table of stored and related dialectic constants, the frequency and angle of transmission best adapted to yield a reflected signal to identify the dielectric constant might be used.

Also, the system is not limited to simply two pulses from two antennas at different frequencies. More than two may be employed. For instance, if a third frequency is employed in the plurality of broadcast pulses through a slice of roadway, a third transmitter and antenna may be located on the vehicle and the tracking the software will cause a third transmitted pulse when in position to energize the same slice as the first antenna.

Once all of the sliced images have been attained and associated with GPS locations on any roadway, software may be employed to use the data of each section to graphically depict the underlying surface of the roadbed at any given point on the roadway. By colorizing the video depiction of different underlying components, such as red for metal, green for concrete, blue for air or lack of material, and purple for oxidized metal, a colorized depiction of the underlying roadway may be provided to the user which identities each desired component at each point at each sliced view along the entire roadway.

Defects are thereby rendered easily identifiable to users viewing a video screen of the virtual roadway and the view may be adjusted using software to assemble a graphic depiction of the entire roadway, or portions and sections of it, from assembled adjoining section images, through the roadbed along the route desired. The image may be electronically adjusted to be viewed from above, below, or from the sides or at angles using graphic depiction software adapted to rotate and render an image on the video screen.

The components allowing the employment of this advanced data acquisition, image processing and roadway diagnostic system, as noted, are designed to be vehicle mounted or trailer mounted and to be pulled by a towing vehicle. The inspection of the underlying roadway on which the inspection vehicle is traveling, is thus done at traffic speeds which are in effect, over a bridge deck, roadway or through a tunnel. This eliminates traffic jams that conventional inspections cause and also increases the speed of the inspection greatly.

The disclosed device enabling and method herein, may employ any plurality of separate antenna arrays, to broadcast and receive reelected RF signals which may be employed with software to image individual slices or sections through the underlying roadbed. The assembling of a final assembled sectional image, from the plurality of RF pulse reflections at different frequencies and/or angles reflected through the roadway section, is adapted well to produce a very high volume of data points on each sliced rendition of the underlying roadway. This high volume of data points produces an enhanced visualization on display screens of the image of the surface below the concrete or asphalt of the roadway. The images so produced of the roadbed are of a quality similar to a digital camera which employs a high number of pixels required to obtain a high resolution image.

Using the assembled section views from multiple pulses from multiple transmitters and antennas, at multiple frequencies and/or angles, the assembled section views are integrated and processed with a data processor and software adapted to the task, to produce a very high resolution image of the roadway beneath the road surface. The combined sectional images using the plurality of different RF signal reflections from different angles, frequencies and polarizations, may be stacked and/or overlaid using the software and processor, to thereby produce a high-resolution, three dimensional, image of the roadway substrate or roadbed under the road surface. This, enhanced assembled imaging system, thereby makes the formerly subjective process of ascertaining a roadbed section in need of maintenance, into an objective standard based on high resolution three dimensional, rotatable images. These images may be stored or transmitted for remote viewing at a later time.

The device employs electromagnetic radar pulses in the microwave spectrum band, from Ultra High Frequency (328.6 megahertz-2.9 gigahertz) to Super High Frequency (2.9 gigahertz-30.0 gigahertz) to communicate through and reflect from the subsurface below the roadway and provide the electronic image of the subsurface. There are numerous system configurations which can be used effectively to obtain both penetration and a high resolution image, and the system may be adapted to conditions by varying frequency and polarization and broadcast angles and reflection-receipt angles, to provide the best resolution to the images of the roadway below the top surface.

Employing the imaging system in the device and method herein, has a number of advantages over conventional systems. Broadly speaking, the ability to employ any frequency and a very large bandwidth facilitates very high data rate communications. The employment of short transmission pulses also facilitates high resolution measurement in radar systems. The Ultra Wide Band broadcast systems lend themselves to a substantially all-digital implementation, with consequent cost savings and improved radar system performance.

In a currently preferred mode of the device yielding detailed sectional views of differing materials in sliced and assembled views through the roadway, a received reelected transmission pulse at a first frequency range, and/or angle or polarization, yields a first image, and a received reflected pulse at a second frequency and/or reflection angle and/or polarization, through the section, yields a second image. The first transmission, if transmitted in the lower frequency range, penetrates deeper into the ground and roadbed and while providing an image in the section at lower resolution, serves to provide a thicker or complete view through the roadbed in the sliced section view. The second frequency would be in the higher range, and while providing less ground penetration, it does provide higher image resolution for the shorter distance through a slice.

Currently, the combined assembled image from the plurality of two reflected pulses uses a lower frequency in the range of 0.3 to 3.5 Ghz in one transmitted pulse, and a pulse in the higher frequency of 9.0 to 12.0 Ghz. This allows for an assembled image from the plurality of transmission reelections from each pulse assembled into a single section view image through the roadbed. The assembled image is digitally assembled from the two or more individual images of the individual section reflected through the roadbed. The initial and combined images of the roadbed sections, are obtained using software to render a sliced or section view based on the received reflected energy at the higher and at the lower frequency and/or using different angles and polarizations. The assembled section image of the roadbed, assembled by software from the two or more images yielded by different RF transmissions, at the two or more different frequencies and/or angles and/or polarizations modes, provides high resolution of individual reinforcing components and complete rendering of each individual section of the non-metal materials forming the roadway and support layers in the section view.

As noted, more pulsed RF transmissions through each section of roadway may be employed at different angles, and different frequencies, and different polarizations, to yield images from their respective reflected energy. Thus, the data and resulting detail of any single image from a reflection through a section, may be adjusted by changing one or a combination of frequency, amplitude, phase, angle of transmission, and polarization mode. All of the images, having been taken and tagged to a specific sectional view point through the roadbed, may then be digitized and combined by software to yield a signal assembled image which depicts the underlying portions of the roadbed through the slice point.

With respect to the above description, before explaining at least one preferred embodiment of the herein disclosed roadway inspection invention in detail, it is to be understood that the invention is not limited in its application to the details of construction and to the arrangement of the components in the following description or illustrated in the drawings. The device and method herein described are capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosed device for the inspection of roadways and bridges for substrate conditions. It is important, therefore, that the claims be regarded as including such equivalent construction and methodology insofar as they do not depart from the spirit and scope of the present invention.

It is an object of this invention to provide a device for production of high resolution images of a roadway underlying the top surface of that roadway on which vehicles run.

It is an additional object of this invention to provide such an inspection system that allows great adaptability as to frequencies employed in transmitted RF pulses, and angles of broadcast and reception of those RF pulses, to allow the device to adapt to conditions at different sites, and to better render specific materials.

It is a further object of the invention herein, to provide such high resolution assembled images which are easily registered to positions on the roadway using GPS tags for each sliced view through the roadway produced.

A further object of the invention is providing a graphic interface where the individual sliced images may be assembled into a complete roadway image.

These together with other objects and advantages which become subsequently apparent reside in the details of the construction and operation as more fully hereinafter described and claimed, reference being had to the accompanying drawings forming a part thereof, wherein like numerals refer to like parts throughout.

### BRIEF DESCRIPTION OF DRAWING FIGURES

FIG. 1 shows the device having multiple antenna arrays engaged in a vehicle to transmit and receive pulsed RF signals to through the roadbed. Data from reflections is communicated to onboard computers or to remote data processors to form sectional depictions of the roadbed.

FIG. 2 shows the combination of a plurality of section images of an individual section to an assembled section image.

FIG. 3 depicts an image of individual sections of the underlying roadbed.

FIG. 4 depicts an antenna array transmitting and receiving pulsed signals at A3, which is another angle from that of the pulsed RF signals of FIG. 1.

FIG. 5 depicts the method employing the device herein to produce enhanced images of a roadbed underlying a roadway.

### DETAILED DESCRIPTION OF THE PREFERRED EMBODIMENTS OF THE INVENTION

The disclosed device 10 and method will utilize a plurality of separate antenna arrays to capture data points from the substrate of the roadway underlying the driving surface. Thus, the disclosed device 10 and method produces a very high volume of radio frequency data points, which, in a manner similar to a digital camera, with a high number of pixels, produces a very high resolution image of individual sections 12 of the underlying roadbed 12.

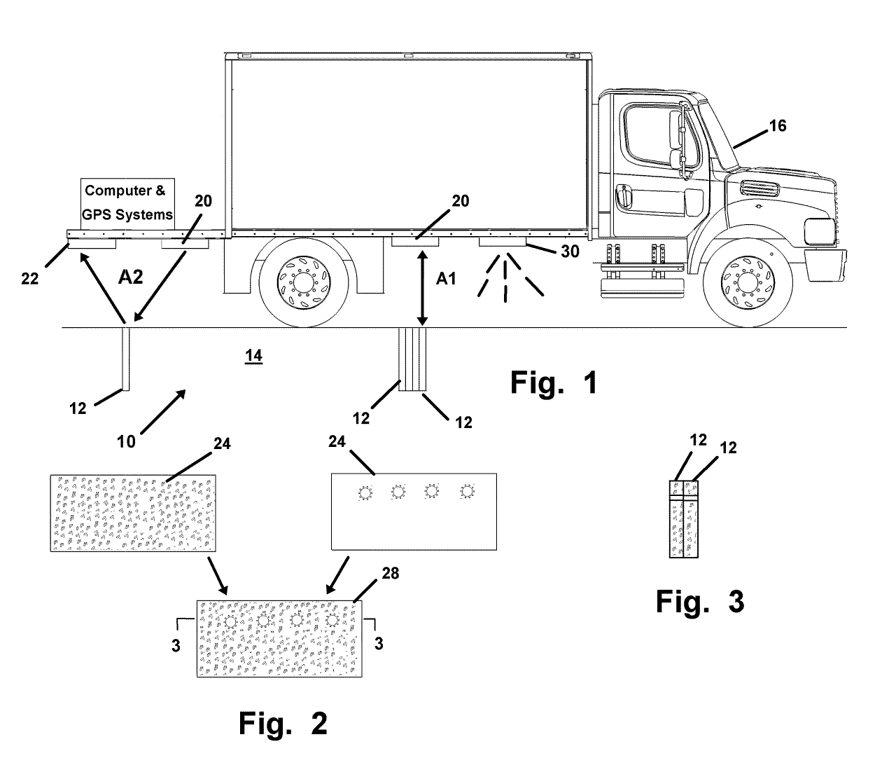

As seen in FIG. 1, the device 10 employs multiple antenna arrays engaged in a vehicle 16 to transmit and receive pulsed RF signals to through the roadbed 14. Each array features a transmitting antenna 20 and receiving antenna 22 which using pulsed transmission may also be the same antenna depending on the angle of transmission desired.

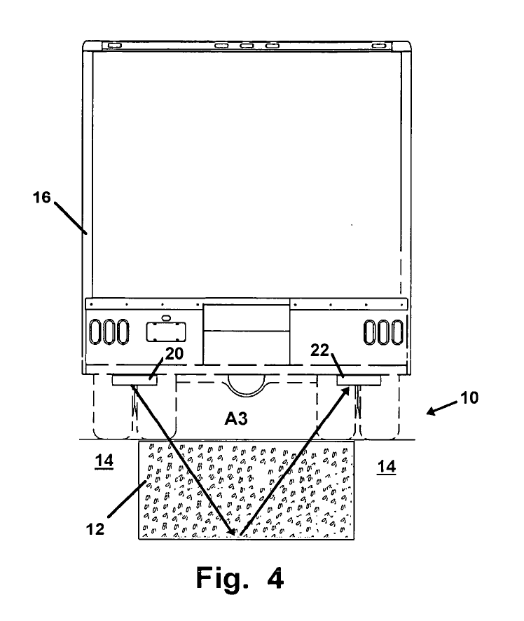

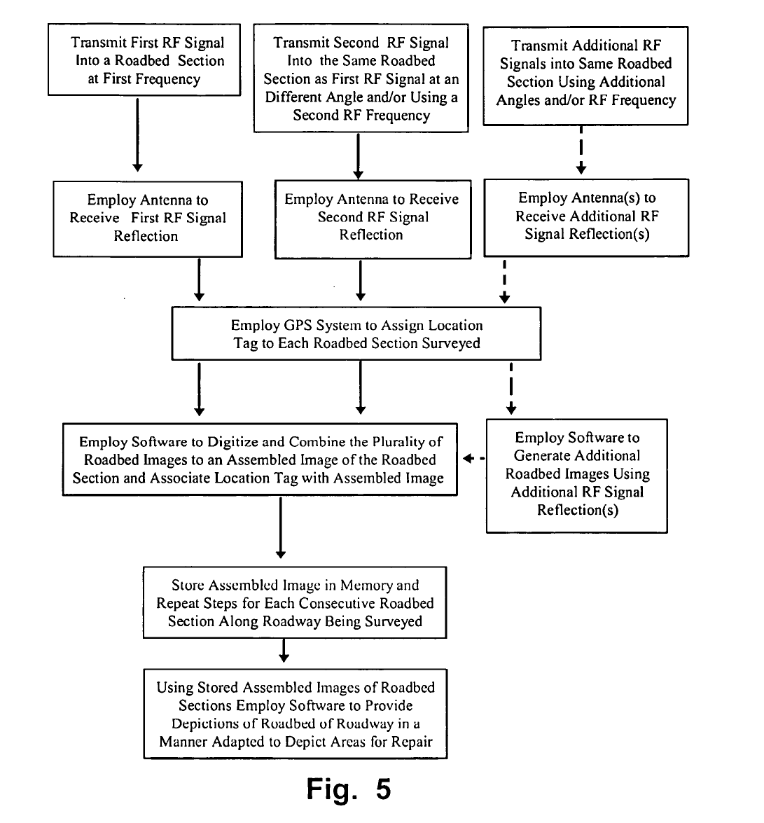

RF transmissions may be at angles perpendicular to the roadbed 14 such as A1, or at angles to communicate through the section 12 as in A2 along the path of the vehicle 16 or traverse to the path of the vehicle 16 as in A3 in FIG. 4.

Means to adjust the data received in the reflected transmissions at the receiving antenna 22 to enhance the image formed therewith, include one or a combination of transmission adjustments from a group including, transmission and reflection angles, polarization, frequency, amplitude, and phase. Changing one or a combination of these variables allows customization of the received RF reflection to provide data points for each image formed by software from those reflective RF signals. Consequently, the RF transmissions communicated through each section 12 to a receiving antenna 22, may be adjusted to enhance the software generated imaging from the received RF transmission having communicated through the section 12. The enhanced images 24 may be adjusted using any of the transmission adjustments above, to render different components of the roadbed 14 better or worse in the resulting plurality of software generated section images 24. The initial section images 24 as noted, are digitized and combined to yield an assembled image 28 of the section 12.

In a currently preferred mode of the device 10 yielding detailed assembled images 28 of sections 12, the received reelected RF transmission at a receiving antenna 22 at a first frequency range, and/or angle and/or polarization, yields a first images 24. The received reelected RF transmission at a receiving antenna 22 in a second frequency and/or reflection angle and/or polarization, through the section 12, yields a second initial image 24.

The first RF transmission, if transmitted in the lower frequency range, penetrates deeper into the roadbed but provides a software generated initial image 24 from the RF reflection at lower resolution but in a complete view through the section 12. The second RF transmission, at a second frequency in the higher range, provides less roadbed penetration with higher image resolution of the underlying objects in the roadbed. The device 10 and method need not limit the number of initial images 24 to two but may be any number needed which can be combined to the assembled image 28 by software on a computer adapted to the task. Consequently, multiple RF transmissions through the section 12 could be three or more with each having adjustments noted above in the RF transmission to yield the data points in the received RF energy through the section 12 to enhance a certain element of the underlying roadbed.

Currently, the combined assembled image 28 from the plurality of two reflected RF transmissions, uses a lower frequency in the range of 0.3 to 3.5 Ghz in one RF transmitted pulse, and a second RF transmission pulse in the higher frequency of 9.0 to 12.0 Ghz. This allows for an assembled image 28 from the plurality of transmission reelections from each RF pulse with sufficient detail of metal and other objects as well as sufficient depth through the section 12 of the roadway 14 to ascertain that nothing of importance has been missed.

The resulting assembled image 28 of the roadbed 14 section 12 assembled by software from the two or more initial images 24 yielded by different RF transmissions, at the two or more different frequencies and/or angles and/or polarizations modes, provides high resolution of individual reinforcing components and complete rendering of each individual section 12 of the non metal materials forming the roadbed 14 and support layers in the section view.

As shown in FIG. 2 the combination of a plurality of initial images 24 of an individual section 12 to an assembled section image 28 yields a combined image that exceeds the detail of either of the initial images 24.

The received electromagnetic information in the form of reflected RF transmissions to reception antennas 20, may be stored electronically. Employing data processors and software adapted to the task, the data points yielded from the individual RF reflections may be integrated and the processed information may be stacked and/or overlaid, to thereby produce the high resolution, rotatable, three dimensional image of the roadway concrete substrate in the assembled image 28. The individual sections 12 images may be assembled and rotated as in FIG. 3 or viewed from any angle that 3D rendering software using the images can produce.

The device broadcasts and receives electromagnetic radar pulses, in the microwave spectrum band, from Ultra High Frequency (328.6 megahertz-2.9 gigahertz) to Super High Frequency (2.9 gigahertz-30.0 gigahertz) to image the subsurface from a plurality of angles. It can detect features in the ground such as voids, cracks, objects and changes in material by detecting variations in the return signal, due to the transmitted pulse reflecting off an object or boundary with different dielectric constants.

A transmit frequency greater than 900 megahertz is particularly favored for use to obtain high resolution data for concrete bridge deck evaluation. In general, the higher the transmit frequency, the higher the image resolution, but lower penetration depth. Consequently, using multiple RF transmissions as noted above to yield multiple combinable initial images 24 can be used effectively to obtain both penetration and a high resolution image in the assembled image 28.

Numerous designs of transmit antennas 22 and receiving antennas 20 distributed over the multiple arrays on the vehicle 16 are employed to overcome specific problems, such as transmission and reception in certain environments, transmitting specific polarization signals and broad band signals having specific phase and polarization characteristics and electronically beam scanning using phased array antenna systems.

In the device 10 herein, where RF signals are not practical or feasible for inspection due to penetration limitations such as steel casings, ultra-sound inspection may be employed. The device will be equipped with an ultrasonic phased array broadcast and receiving system 30 that can be employed in almost any test where conventional ultrasonic flaw detectors have traditionally been used. Weld inspection and crack detection are the most important applications. The phased array design can be effectively used to profile remaining wall thickness in corrosion inspection applications.

The disclosed device enabling the method herein, will provide a multi-sensor bridge deck and roadway evaluation system employing the latest technology in both ultrasound and digital RF radar array systems. The unique multi-sensor/multi-array design will improve angular data rates employable to produce imaging of the substrate of the roadway, by several orders of magnitude.

Employing multi-sensor antenna apertures in the disclosed device enables independent views of sections 12 the target area of the roadbed 14 using independent pulse patterns. Using the stored data from the RF reflections through the sections 12 from many angles and at the chosen frequencies, in conjunction with a data processor and computer aided design (CAD) software, a computer simulation and modeling of the substrate of the roadbed 14 may be produced in great detail. Rather than the subjective system conventionally employed as noted above, the device herein provides the ability to perform computer simulation and modeling of the underlying road structure to look for damage or wear and thereby removes any “guess work.”

In addition to the visual images produced, which may be inspected by users, by employing software to compare the amplitude of each of the plurality of RF signals, and the respective phase of each such RF signal, relative to the same elements in individual respective reflected signals received, a dielectric constant for any point in any section 12 electronic image through the roadbed 14 may be determined. Using determined lookup tables, of the values of individual dialectic constants, which are related to individual physical materials, and comparing each determined dialectic constants for each point in the section 12 view through the roadbed to the table, the material existing at any such point in each section 12 through the roadbed 14 may be determined.

Thus metal may be determined from concrete, and by type. Air adjacent to the metal may show air pockets which also will define cracks. Rust on the metal may be determined by its dialectic constant, at its point in a section 12 view, which like other components, will have a reflected energy return in the received RF signal showing it is rust by the determined dialectic constant.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A mobile apparatus for production of images of a roadbed underlying a roadway, comprising:
means for transmission of a first RF transmission through a section of said roadbed to a first receiving antenna;
means for transmission of a second RF transmission through said section of said roadbed to a second receiving antenna;
software running on a computer configured to receive said first RF transmission communicated to said first receiving antenna and produce a first electronic image depicting said section of said roadbed;
said software running on said computer configured to receive said second RF transmission communicated to said second receiving antenna and produce a second electronic image depicting said section of said roadbed;
means to ascertain a terrestrial location of said section of said roadbed and provide an association of said location with said section;
said software running on said computer configured to combine said first electronic image and said second electronic image into an assembled electronic image of said section of said roadbed;
said computer having electronic memory in operative communication therewith and adapted for storage of said assembled electronic image of said section and said associated location of said section; and
whereby said mobile apparatus engaged upon a vehicle traveling along said roadway operates to transmit each of said first and second RF transmissions through a plurality of individual said sections of said roadbed to produce individual respective said assembled electronic images of each of said plurality of said sections along a direction of travel of said vehicle to provide series of said assembled electronic images each having a said terrestrial location associated therewith.

2. The mobile apparatus for production of images of a roadbed underlying a roadway of claim 1 additionally comprising:
said means for transmission of a first RF transmission transmitting at a frequency higher than a second frequency transmitted by said means for transmission of a second RF transmission.

3. The mobile apparatus for production of images of a roadbed underlying a roadway of claim 1 additionally comprising:
said first receiving antenna being located at a position on said vehicle closer to a front of said vehicle;
said second receiving antenna being located at a position on said vehicle closer to a rear of said vehicle; and
means to trigger said means for transmission of a second RF transmission to cause said second RF transmission to communicate through said same section as said first RF transmission; whereby said first and second receiving antennas may be located in different axial positions on said vehicle and still communicate through the same said section.

4. The mobile apparatus for production of images of a roadbed underlying a roadway of claim 1 additionally comprising:
said first RF transmission adjustable to provide an enhanced depiction of particular materials in a resulting said first electronic image through employment of one or a combination of a group of adjustments including, adjusting the frequency of said first RF transmission, adjusting an angle of said first RF transmission toward said section, adjusting a polarization of said first RF transmission; and
said second RF transmission adjustable to provide an enhanced depiction of particular materials in a resulting said second electronic image through employment of one or a combination of a group of adjustments including, adjusting the frequency of said first RF transmission, adjusting an angle of said first RF transmission toward said section, adjusting a polarization of said first RF transmission.

5. The mobile apparatus for production of images of a roadbed underlying a roadway of claim 2 additionally comprising:
said first RF transmission adjustable to provide an enhanced depiction of particular materials in a resulting said first electronic image through employment of one or a combination of a group of adjustments including, adjusting the frequency of said first RF transmission, adjusting an angle of said first RF transmission toward said section, adjusting a polarization of said first RF transmission; and
said second RF transmission adjustable to provide an enhanced depiction of particular materials in a resulting said second electronic image through employment of one or a combination of a group of adjustments including, adjusting the frequency of said first RF transmission, adjusting an angle of said first RF transmission toward said section, adjusting a polarization of said first RF transmission.

6. The mobile apparatus for production of images of a roadbed underlying a roadway of claim 3 additionally comprising:
said first RF transmission adjustable to provide an enhanced depiction of particular materials in a resulting said first electronic image through employment of one or a combination of a group of adjustments including, adjusting the frequency of said first RF transmission, adjusting an angle of said first RF transmission toward said section, adjusting a polarization of said first RF transmission; and
said second RF transmission adjustable to provide an enhanced depiction of particular materials in a resulting said second electronic image through employment of one or a combination of a group of adjustments including, adjusting the frequency of said first RF transmission, adjusting an angle of said first RF transmission toward said section, adjusting a polarization of said first RF transmission.

7. The mobile apparatus for production of images of a roadbed underlying a roadway of claim 1 additionally comprising:
an ultrasonic phased array broadcast and receiving system for communicating a sonic transmission through said section; and
said software configured to produce a third electronic image and combine it with one or both of said first and second electronic images to form said assembled electronic image.

8. The mobile apparatus for production of images of a roadbed underlying a roadway of claim 2 additionally comprising:
an ultrasonic phased array broadcast and receiving system for communicating a sonic transmission through said section; and
said software configured to produce a third electronic image and combine it with one or both of said first and second electronic images to form said assembled electronic image.

9. The mobile apparatus for production of images of a roadbed underlying a roadway of claim 3 additionally comprising:
an ultrasonic phased array broadcast and receiving system for communicating a sonic transmission through said section; and
said software configured to produce a third electronic image and combine it with one or both of said first and second electronic images to form said assembled electronic image.

10. The mobile apparatus for production of images of a roadbed underlying a roadway of claim 4 additionally comprising:
an ultrasonic phased array broadcast and receiving system for communicating a sonic transmission through said section; and
said software configured to produce a third electronic image and combine it with one or both of said first and second electronic images to form said assembled electronic image.

11. The mobile apparatus for production of images of a roadbed underlying a roadway of claim 5 additionally comprising:
an ultrasonic phased array broadcast and receiving system for communicating a sonic transmission through said section; and
said software configured to produce a third electronic image and combine it with one or both of said first and second electronic images to form said assembled electronic image.

12. The mobile apparatus for production of images of a roadbed underlying a roadway of claim 6 additionally comprising:
an ultrasonic phased array broadcast and receiving system for communicating a sonic transmission through said section; and
said software configured to produce a third electronic image and combine it with one or both of said first and second electronic images to form said assembled electronic image.

13. A method of producing sectional images of a roadbed underlying a roadway employing the apparatus of claim 1, comprising the steps of:
triggering said means for transmission of said first RF transmission to communicate through said section of said roadbed to said first receiving antenna;
triggering said means for transmission of said second RF transmission at a time causing said second RF transmission to communicate through the same said section of said roadbed as said first RF transmission, and be received by said second receiving antenna;
employing said software running on said computer configured to produce said first electronic image depicting said section of said roadbed;
employing said software running on said computer to produce said second electronic image depicting said section of said roadbed;
employing a means to ascertain a terrestrial location of said section and providing an association of said location with said section;
employing said software running on said computer to combine said first electronic image and said second electronic image into an assembled electronic image of said section of said roadbed;
storing said assembled electronic image of said section and said associated location of said section upon said computer; and
employing said assembled electronic image of any said section imaged, to provide a sectional image of a said section to ascertain whether maintenance is required in said roadbed under said roadway at said section.
